(19) United States
(12) Patent Application Publication
(10) Pub. No.: US 2019/0097276 A1
(43) Pub. Date: Mar. 28, 2019

(54) CHARGING DEVICE AND ELECTRONIC DEVICE

(71) Applicant: Panasonic Intellectual Property Management Co., Ltd., Osaka (JP)

(72) Inventor: YUTAKA TANAKA, Hyogo (JP)

(21) Appl. No.: 16/055,049

(22) Filed: Aug. 4, 2018

(30) Foreign Application Priority Data
Sep. 27, 2017 (JP) 2017-186618

(51) Int. Cl. H01M 10/44; H02J 7/04; H02J 7/00; H04N 5/374

(52) U.S. Cl. CPC H01M 10/44; H02J 7/045; H02J 2007/0062; H04N 5/374; H02J 7/0052

(57) ABSTRACT

A charging device includes a charger configured to use power entered from an external device to charge a secondary battery with a charging current at a set current value, and a charging controller configured to set the current value. The charging controller sets, at beginning of charging of the secondary battery, the current value to a set value among a plurality of predetermined set values, and sets, during charging of the secondary battery, when an input voltage from the external device lowers below a predetermined value, the current value to another set value among the plurality of set values.

### BACKGROUND

### 1. Technical Field

The present disclosure relates to a charging device configured to use power supplied from an external device to charge a built-in secondary battery, and an electronic device equipped with the charging device.

### 2. Description of the Related Art

Unexamined Japanese Patent Publication No. 2010-154692 discloses a charging device in an electronic device. The charging device is configured to charge a secondary battery provided in the electronic device. The charging device includes a detection unit, a charging unit, a measurement unit, and a control unit. The detection unit is configured to detect another electronic device coupled via a communication cable. The charging unit is configured to charge the secondary battery with a power supply voltage supplied from a power supply line of the communication cable. The measurement unit is configured to measure a measurement value indicative of a degree of voltage drop in the power supply voltage due to a charging operation of the charging unit. The control unit is configured to instruct a charging current value used to charge the secondary battery to cause the charging unit to perform charging. When the detection unit detects the other electronic device being coupled, the control unit increases the charging current value instructed to the charging unit from an initial current value, monitors a measurement value of the measurement unit, and determines the charging current value based on a result of the monitoring on the measurement value.

With the configuration, even when information required for charging, such as a standard current, cannot be acquired from another electronic device being coupled, a secondary battery is charged stably with a charging current value determined based on a result of monitoring.

### SUMMARY

The present disclosure provides a charging device capable of using power supplied from one of various types of external devices to effectively charge a battery, and an electronic device equipped with the charging device.

A charging device according to a first aspect of the present disclosure includes a charger configured to charge a secondary battery with a charging current at a current value being presently set, the charging is carried out by using power entered from an external device; and a charging controller configured to set the current value. The charging controller sets, at beginning of charging of the secondary battery, the current value to a set value among a plurality of set values predetermined. The charging controller sets, during charging of the secondary battery, when an input voltage from the external device lowers below a predetermined value, the current value to another set value among the plurality of set values.

An electronic device according to a second aspect of the present disclosure includes a rechargeable secondary battery, and the charging device configured to charge the rechargeable secondary battery, according to the first aspect of the present disclosure.

### BRIEF DESCRIPTION OF THE DRAWINGS

FIG. 1 is a view illustrating that a digital camera that is an electronic device according to one exemplary embodiment of the present disclosure and a universal serial bus (USB) power supply adaptor that is an example of an external device are coupled to each other;

FIG. 2 is a view illustrating a configuration of the digital camera that is the electronic device according to the one exemplary embodiment of the present disclosure;

FIG. 3 is a view illustrating a configuration of a charging circuit according to the one exemplary embodiment of the present disclosure;

FIG. 4 is a flowchart illustrating a process executed by a microcontroller in the charging circuit when an external device is coupled to a USB terminal;

FIG. 5 is a flowchart illustrating a charging control process for USB power supply adaptor, according to a first exemplary embodiment;

FIG. 6 is a graph illustrating time variations in battery voltage, charging current, output voltage of the USB power supply adaptor, and output current of the USB power supply adaptor while the battery is being charged (when a set value for a charging current is not switched);

FIG. 7 is a graph illustrating time variations in battery voltage, charging current, output voltage of the USB power supply adaptor, and output current of the USB power supply adaptor while the battery is being charged (when the set value for the charging current is switched);

FIG. 8 is a flowchart illustrating a charging control process for USB power supply adaptor, according to a second exemplary embodiment;

FIG. 9 is a flowchart illustrating a process of determining and setting a charging current in the charging control process for USB power supply adaptor, according to the second exemplary embodiment (when a starting point of a charging current is set to a third set value); and

FIG. 10 is a flowchart illustrating a process of determining and setting a charging current in the charging control process for USB power supply adaptor, according to the second exemplary embodiment (when the starting point of the charging current is set to a second set value).

### DETAILED DESCRIPTION

Exemplary embodiments will be described in detail below with reference to the drawings as appropriate. However, a detailed description more than necessary may be omitted. For example, a detailed description of well-known matters, and a duplicate description of substantially identical configurations may not be provided. This is to avoid unnecessary redundancy in the following description and to facilitate understanding of those skilled in the art.

The inventor of the present disclosure provides the accompanying drawings and the following description in order to allow those skilled in the art to fully understand the present disclosure, and does not intend to limit the subject matter described in the appended claims by the accompanying drawings and the following description.

### [1-1. Configuration]

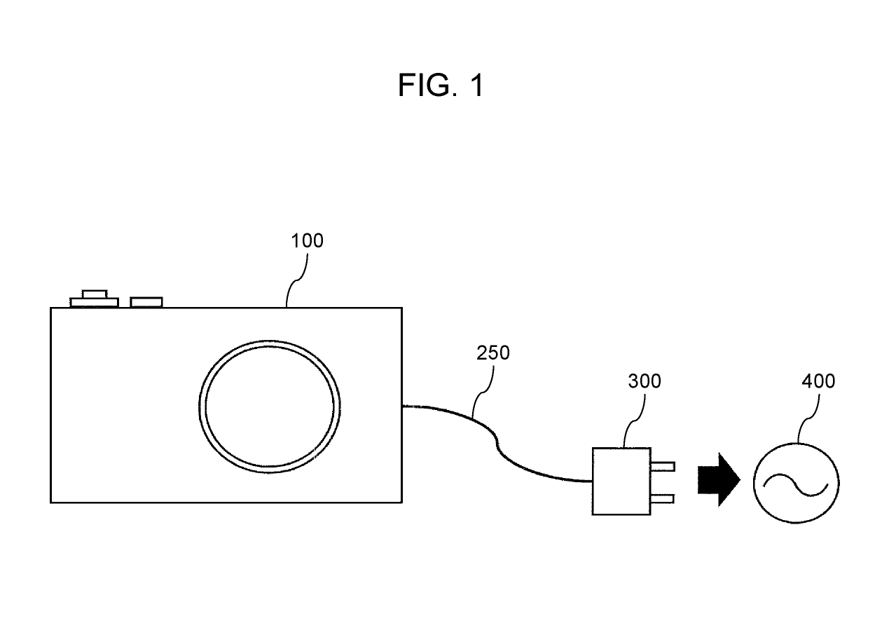

FIG. 1 is a view illustrating that digital camera 100 that is an electronic device according to one exemplary embodiment of the present disclosure and universal serial bus (USB) power supply adaptor 300 that is an example of an external device are coupled to each other. Digital camera 100 includes a USB terminal configured to couple the external device compliant with a USB standard. Digital camera 100 is coupled to USB power supply adaptor 300 via USB cable 250 coupled to the USB terminal. USB power supply adaptor 300 is coupled to commercial power supply 400. USB power supply adaptor 300 converts a voltage applied from the commercial power supply into a voltage specified in the USB standard (e.g., 5 V DC) and supplies the voltage to digital camera 100. Digital camera 100 can accept power from USB power supply adaptor 300 to charge a built-in battery.

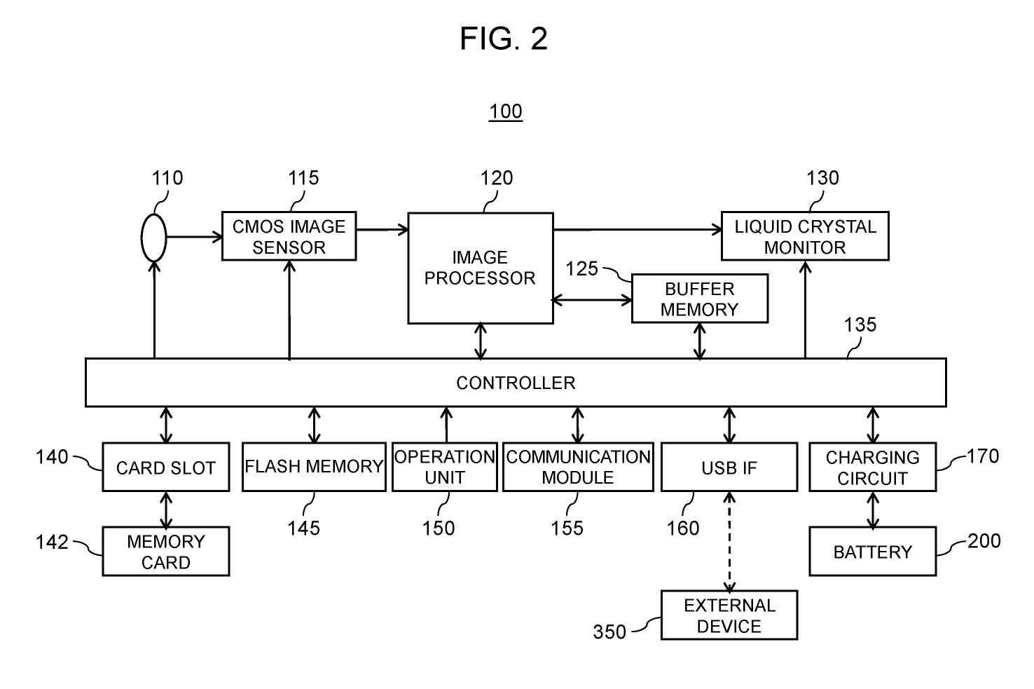

FIG. 2 is an electrical configuration diagram of digital camera 100. Digital camera 100 captures a subject image formed via optical system 110 by means of complementary metal oxide semiconductor (CMOS) image sensor 115. CMOS image sensor 115 generates captured-image data (raw data) based on the captured subject image. Image processor 120 performs various types of processing on the captured-image data generated through capturing to generate image data. Controller 135 records the image data generated by image processor 120 in memory card 142 inserted into card slot 140. In addition, controller 135 can display (i.e., reproduce) the image data recorded in memory card 142 on liquid crystal monitor 130 in accordance with an operation on operation unit 150 performed by a user.

Digital camera 100 is coupled to external device 350 via the USB cable. Digital camera 100 performs communication in compliance with the USB standard with external device 350. Digital camera 100 can accept power compliant with the USB standard from external device 350 and can charge built-in battery 200 with the accepted power.

Optical system 110 includes a focusing lens, a zoom lens, an optical camera-shake correction lens (or an optical image stabilizer (OIS)), an aperture, and a shutter, for example. Optical system 110 may include any number of various lenses. Optical system 110 may include any number of lens groups.

CMOS image sensor 115 captures a subject image formed by optical system 110 to generate captured-image data. CMOS image sensor 115 generates image data of a new frame at a predetermined frame rate (for example, 30 frames per second). Controller 135 controls a generation timing of captured-image data and an electronic shutter operation for CMOS image sensor 115. An imaging element is not limited to the CMOS image sensor. Alternatively, the imaging element may be another image sensor such as a charge coupled device (CCD) image sensor or an n-channel metal-oxide semiconductor (NMOS) image sensor.

Image processor 120 performs various types of processing on the captured-image data output from CMOS image sensor 115 to generate image data. Furthermore, image processor 120 performs the various types of processing on the image data read from memory card 142 to generate an image to be displayed on liquid crystal monitor 130. Examples of the various processes include, but not limited to, a white balance correction, a gamma correction, a YC conversion process, an electronic zoom process, a compression process, and an expansion process. Image processor 120 may include a hard-wired electronic circuit, a microcomputer using a program, or the like.

Liquid crystal monitor 130 is secured to or movably attached to a back of digital camera 100. Liquid crystal monitor 130 displays an image based on the image data processed by image processor 120. A display device is not limited to a liquid crystal monitor. Another monitor, such as an organic electro luminescence (EL) monitor, may be used.

Controller 135 includes a central processing unit (CPU) and performs centralized control on entire operation of digital camera 100. Instead of a CPU, controller 135 may include a hard-wired electronic circuit, a microcomputer, or the like. In addition, controller 135, image processor 120, and the like may configure one semiconductor chip. Controller 135 includes a read only memory (ROM). The ROM is not illustrated in the drawings. The ROM records information necessary for establishing Wi-Fi communication with another communication device, for example. The ROM further records programs to be executed by the CPU. The programs to be recorded include, for example, a program for automatic focus control (AF control), a program for communication control, and a program for centralized control on entire operation of digital camera 100.

Buffer memory 125 is a recording medium serving as a working memory of image processor 120 and controller 135. Buffer memory 125 is implemented by, for example, a dynamic random access memory (DRAM).

Card slot 140 is detachably inserted with memory card 142. Memory card 142 can be electrically and mechanically coupled to card slot 140. Memory card 142 is an external memory provided with a recording element, such as a flash memory. Memory card 142 can store data such as image data generated by image processor 120.

Flash memory 145 is a non-volatile recording medium.

Operation unit 150 is used herein as a general term for hard keys, such as an operation button and an operation lever provided on an exterior of digital camera 100. Operation unit 150 receives a user action. Operation unit 150 is, for example, at least one of a release button, a mode dial, and a touch panel. Upon receipt of a user action, operation unit 150 transmits to controller 135 an operation signal corresponding to the user action.

Communication module 155 is a communication module (e.g., circuit) configured to perform communication in compliance with the communication standard IEEE 802.11. Digital camera 100 can communicate in compliance with a Wi-Fi standard with another device via communication module 155. Digital camera 100 may communicate with another device either directly or through an access point. Note that, in addition to or instead of the Wi-Fi standard, communication module 155 may perform communication in compliance with another communication standard. For example, communication module 155 may perform communication in compliance with a standard, such as Bluetooth (registered trademark), high definition multimedia interface (HDMI) (registered trademark), 3G, or 4G.

USB interface 160 is an interface that is compliant with the universal serial bus (USB) standard and that is configured to couple external device 350 via USB cable 250. USB interface 160 includes the USB terminal that is compliant with the USB standard, and a communication circuit configured to perform communication in compliance with the USB standard. The USB terminal includes a Vbus terminal for power supply and a GND terminal, as well as a D+ terminal and a D− terminal for data transmission. External device 350 is an electronic device capable of performing communication in compliance with the USB standard. External device 350 is, for example, USB power supply adaptor 300 or a personal computer (PC) configured to convert a voltage supplied from a commercial power supply into a voltage specified in the USB standard, and to supply the voltage to an electronic device.

Battery 200 is a power supply configured to supply power to components of digital camera 100. Battery 200 is a rechargeable secondary battery, such as a lithium-ion battery, a nickel-cadmium battery, or a nickel-hydrogen battery.

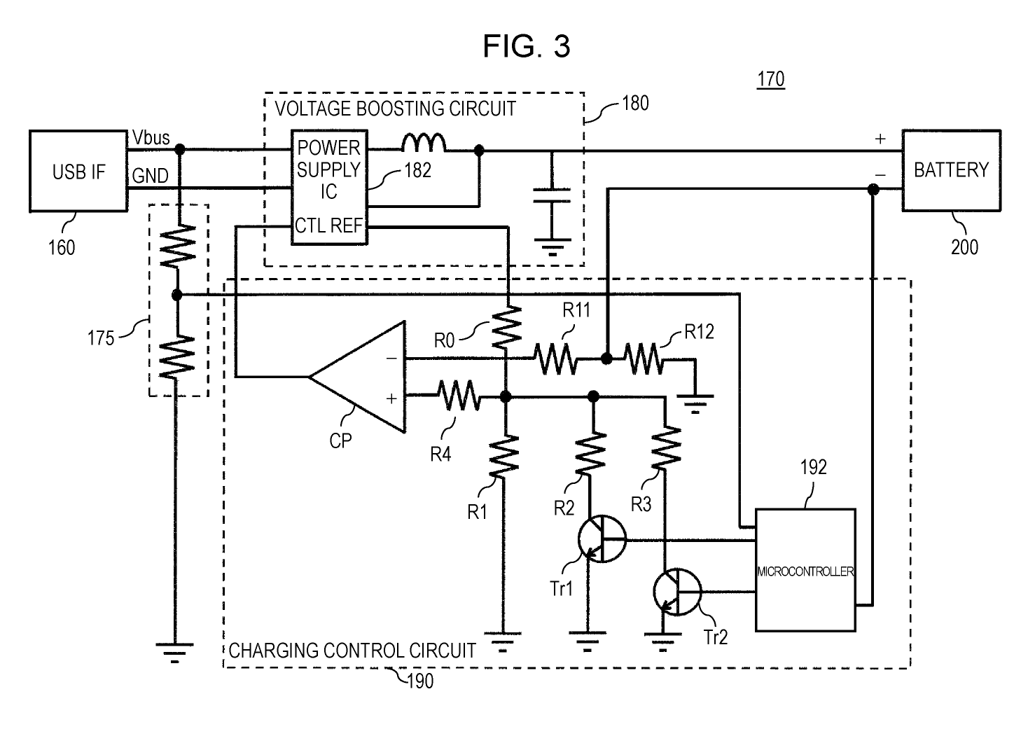

Digital camera 100 can use power supplied from external device 350 coupled to USB interface 160 to charge battery 200. For this purpose, digital camera 100 includes charging circuit 170 (an example of a charging device) configured to charge battery 200. FIG. 3 is a view illustrating a specific configuration of charging circuit 170.

Charging circuit 170 includes input voltage detection circuit 175 configured to detect an input voltage, voltage boosting circuit 180 (an example of a charger) configured to boost up the input voltage to a predetermined voltage, and charging control circuit 190 (an example of a charging controller).

Input voltage detection circuit 175 detects, as an input voltage, a voltage applied from external device 350 coupled to USB interface 160. Specifically, input voltage detection circuit 175 detects, as an input voltage, a voltage (Vbus) at the Vbus terminal compliant with the USB standard.

Voltage boosting circuit 180 converts input voltage Vbus (e.g., 5 V) entered from USB interface 160 into a predetermined voltage (e.g., 8.4 V). Voltage boosting circuit 180 includes power supply integrated circuit (IC) 182 configured to boost up a voltage by using a switching element and a switching control method. Power supply integrated circuit (IC) 182 follows a control signal sent from charging control circuit 190 to switch a charging current to be supplied to battery 200.

Charging control circuit 190 includes comparator CP, a plurality of resistors R0 to R4, R11, and R12, transistors Tr1, Tr2, and microcontroller 192. A negative input terminal of comparator CP is coupled to a low-pressure side terminal of battery 200. In other words, the negative input terminal of comparator CP is fed back with a charging current of battery 200. A positive input terminal of comparator CP is coupled to one end of resistor R4. Another end of resistor R4 is coupled to resistors R1 to R3. A node of resistor R4 and resistors R1 to R3 coupled to each other is coupled to a reference voltage terminal (REF) of power supply IC, via resistor R0. The reference voltage terminal (REF) outputs a predetermined reference voltage.

The positive input terminal of comparator CP accepts a voltage divided by resistors R1 to R4 from the reference voltage. When respective transistors Tr1, Tr2 are turned on and off, resistance values of the resistors coupled to the positive input terminal of comparator CP are respectively switched in three stages. The reference voltage to be applied to the positive input terminal of comparator CP is switched in three stages.

Microcontroller 192 controls and turns on and off respective transistors Tr1, Tr2 based on the input voltage (Vbus) detected by input voltage detection circuit 175. Microcontroller 192 controls and turns on and off respective transistors Tr1, Tr2 to attain three states: transistors Tr1, Tr2 are both turned off, transistor Tr1 is only turned on, and transistors Tr1, Tr2 are both turned on. Comparator CP outputs, to power supply IC 182, as a control signal, a difference between a feedback value on a charging current supplied from battery 200 and a reference voltage determined from resistors R0 to R4. Power supply IC 182 follows a control signal sent from comparator CP to control a charging current for battery 200.

### [1-2. Operation]

A charging operation for battery 200 using power supplied from external device 350 coupled, via USB cable 250, to digital camera 100 configured as described above will now be described.

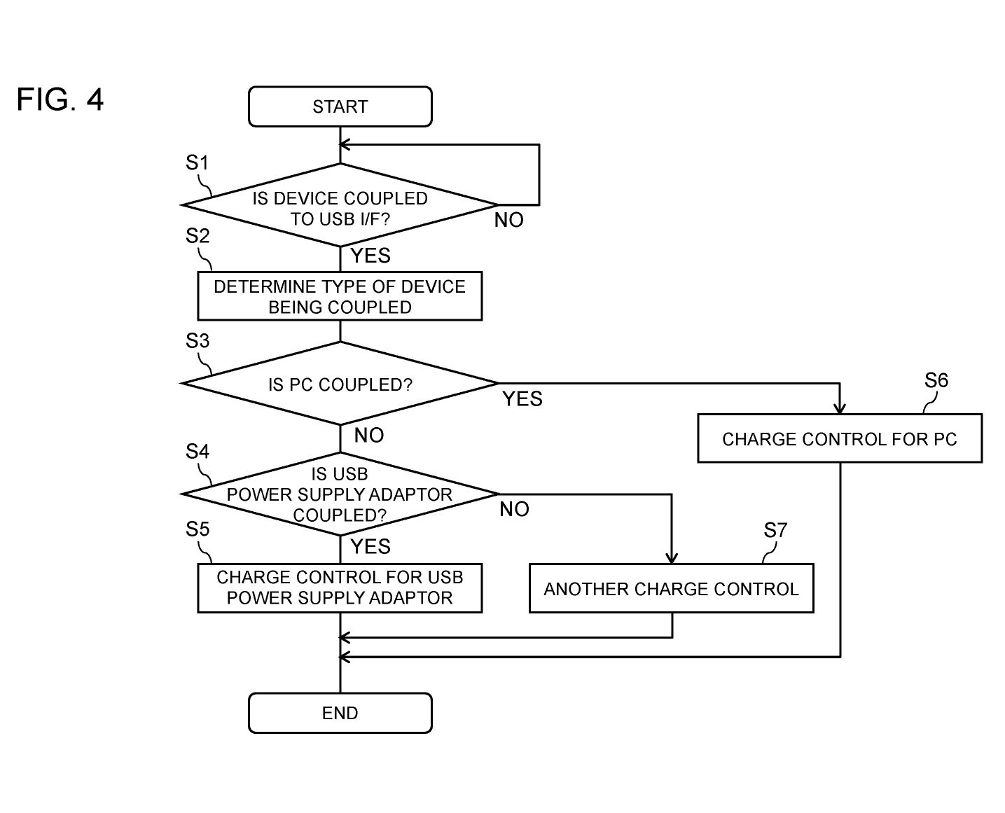

FIG. 4 is a flowchart illustrating a process performed in charging circuit 170 while external device 350 is coupled, via USB cable 250, to digital camera 100. The process is mainly executed by microcontroller 192 in charging circuit 170.

Microcontroller 192 first monitors a voltage at the Vbus terminal of USB interface 160 to determine whether external device 350 is coupled to USB interface 160 (S1). When external device 350 is coupled to USB interface 160 (YES in S1), microcontroller 192 determines a type of external device 350 being coupled (S2). Microcontroller 192 can determine a type of external device 350 being coupled by communicating with external device 350 via the D+ and D− terminals.

When external device 350 being coupled is a personal computer (PC) (YES in S3), microcontroller 192 performs a charge control for PC (S6). On the other hand, when external device 350 being coupled is not a PC (NO in S3), microcontroller 192 determines whether external device 350 being coupled is a USB power supply adaptor (S4).

When external device 350 being coupled is a USB power supply adaptor (YES in S4), microcontroller 192 performs a charge control for USB power supply adaptor (S5). When external device 350 being coupled is not a USB power supply adaptor (NO in S4), microcontroller 192 performs another charge control (S7).

In the charge control for USB power supply adaptor (S5), charging control circuit 190 switches a set value for a charging current in accordance with power supply performance of an individual USB power supply adaptor coupled to USB interface 160. Specifically, charging control circuit 190 is configured to select a set value for a charging current from among three types of set values. In other words, charging control circuit 190 can select and set, as a current value for a charging current, one of a first set value (e.g., 850 mA), a second set value (e.g., 420 mA), and a third set value (e.g., 200 mA). Charging control circuit 190 determines the power supply performance of the USB power supply adaptor coupled to USB interface 160 to switch the set value for the charging current in accordance with the power supply performance. As described above, since charging control circuit 190 sets a current value for a charging current in accordance with power supply performance of an individual USB power supply adaptor (i.e., external device), efficient charging in accordance with the power supply performance of the USB power supply adaptor can be achieved.

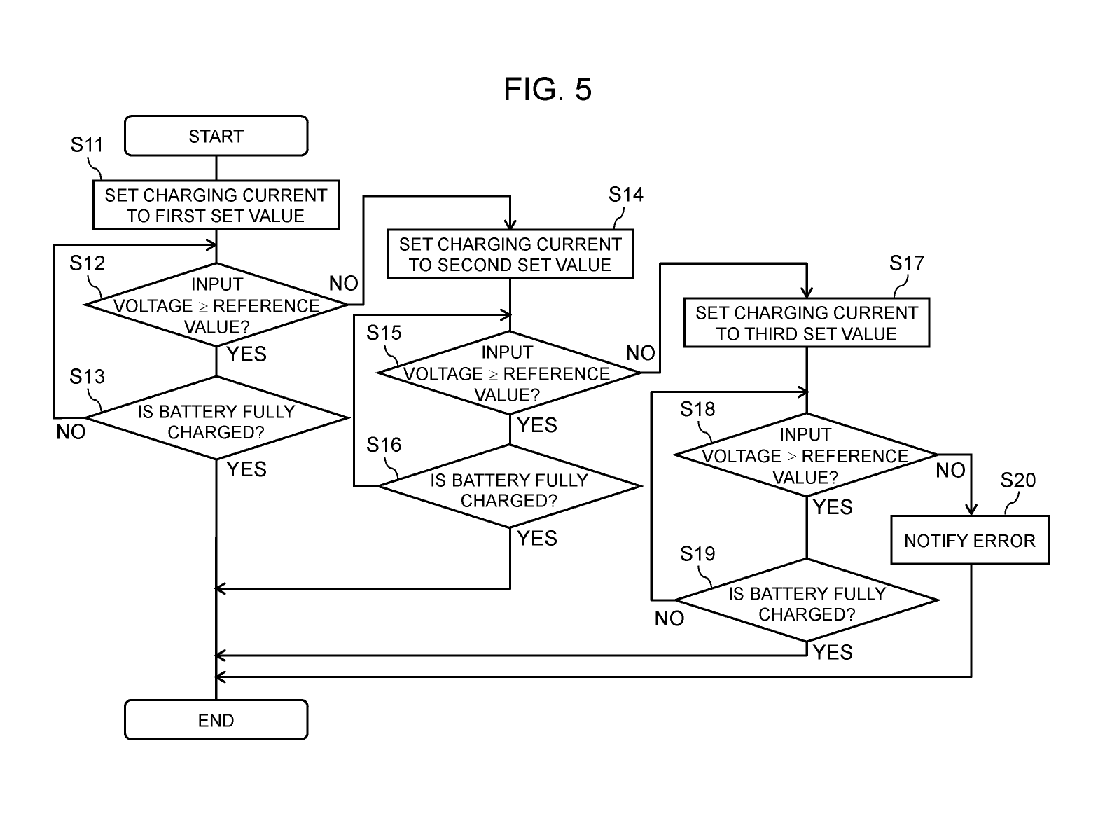

FIG. 5 is a flowchart illustrating processing, performed by microcontroller 192, of the charge control for USB power supply adaptor. The charge control for USB power supply adaptor will now be described with reference to FIG. 5.

Microcontroller 192 in charging circuit 170 first sets a current value for a charging current to be set, i.e., a set value, to the first set value (e.g., 850 mA) that is largest among the three types of the set values set beforehand (S11). At this time, microcontroller 192 turns off both transistor Tr1 and transistor Tr2. In power supply IC 182, the first set value is set as the current value for the charging current. In this state, microcontroller 192 allows voltage boosting circuit 180 to operate and charge battery 200. At this time, when the charging current of 850 mA cannot be fully introduced under power supply performance of USB power supply adaptor 300, an input voltage (Vbus) to be supplied from USB power supply adaptor 300 lowers significantly, i.e., below 5 V.

Microcontroller 192 monitors a value of an input voltage (Vbus) to determine whether the input voltage is equal to or above a reference value (S12). The reference value is set to a value (e.g., 4.7 V) lower than a lower limit value in a power supply voltage range (from 4.75 V to 5.25 V inclusive) specified in the USB standard. As described above, in the exemplary embodiment, microcontroller 192 determines a reduction level of the input voltage (Vbus) supplied from USB power supply adaptor 300 to determine the power supply performance of USB power supply adaptor 300.

When the input voltage is equal to or above the reference value (YES in S12), it can be determined that the charging current can be fully supplied at the first set value under the power supply performance of USB power supply adaptor 300. When the input voltage is equal to or above the reference value (YES in S12), battery 200 is kept charged until battery 200 is fully charged (S13). Microcontroller 192 can determine whether battery 200 is fully charged based on a detected voltage of battery 200. In other words, microcontroller 192 determines that battery 200 is fully charged upon attainment of a battery voltage to a predetermined value (e.g., 8.4 V).

On the other hand, when the input voltage is below the reference value (NO in S12), it can be determined that the charging current cannot be fully supplied at the first set value under the power supply performance of USB power supply adaptor 300. In this case, microcontroller 192 sets the current value for the charging current to the second set value (e.g., 420 mA) that is lower than the first set value (e.g., 850 mA) (S14). At this time, microcontroller 192 turns on transistor Tr1, while turns off transistor Tr2. In power supply IC 182, the second set value is set as the current value for the charging current. In this state, microcontroller 192 charges battery 200.

At this time, microcontroller 192 monitors the input voltage (Vbus) supplied from USB power supply adaptor 300 to determine whether the input voltage is equal to or above the reference value (S15).

When the input voltage is equal to or above the reference value (YES in S15), it can be determined that the charging current can be fully supplied at the second set value under the power supply performance of USB power supply adaptor 300. When the input voltage is equal to or above the reference value (YES in S15), battery 200 is kept charged until battery 200 is fully charged (S16).

On the other hand, when the input voltage is below the reference value in step S15 (NO in S15), it can be determined that the charging current cannot be fully supplied at the second set value under the power supply performance of USB power supply adaptor 300. In this case (NO in S15), microcontroller 192 sets the set value for the charging current to the third set value (e.g., 200 mA) that is lower than the second set value (S17). At this time, microcontroller 192 controls and turns on both transistor Tr1 and transistor Tr2. In power supply IC 182, the third set value is set as the charging current.

Microcontroller 192 monitors the input voltage (Vbus) supplied from USB power supply adaptor 300 to determine whether the input voltage is equal to or above the reference value (S18).

When the input voltage is equal to or above the reference value (YES in S18), it can be determined that the charging current can be fully supplied at the third set value under the power supply performance of USB power supply adaptor 300. When the input voltage is equal to or above the reference value (YES in S18), battery 200 is kept charged until battery 200 is fully charged (S19).

On the other hand, when the input voltage is below the reference value in step S18 (NO in S18), it can be determined that the charging current cannot be fully supplied at the third set value under the power supply performance of the external device. In this case, microcontroller 192 notifies an error to controller 135 (S20). Controller 135 causes liquid crystal monitor 130 to display information (e.g., message or icon) indicative of an abnormality in charging performed by the external device to notify the abnormality to a user.

As illustrated in the flowchart in FIG. 5, in the exemplary embodiment, microcontroller 192 always monitors a value of an input voltage supplied from USB power supply adaptor 300 during charging of battery 200 (S12, S15, and S18) to perform a control so that, when the input voltage is below the reference value, a current value for a charging current is lowered or an error is notified. This controlling is provided due to that, since, as charging of battery 200 advances, USB power supply adaptor 300 is required to further supply power, even when USB power supply adaptor 300 can fully supply power initially, as charging of battery 200 advances, USB power supply adaptor 300 may not fully supply power. In such a case, lowering a current value for a charging current allows USB power supply adaptor 300 to fully supply power.

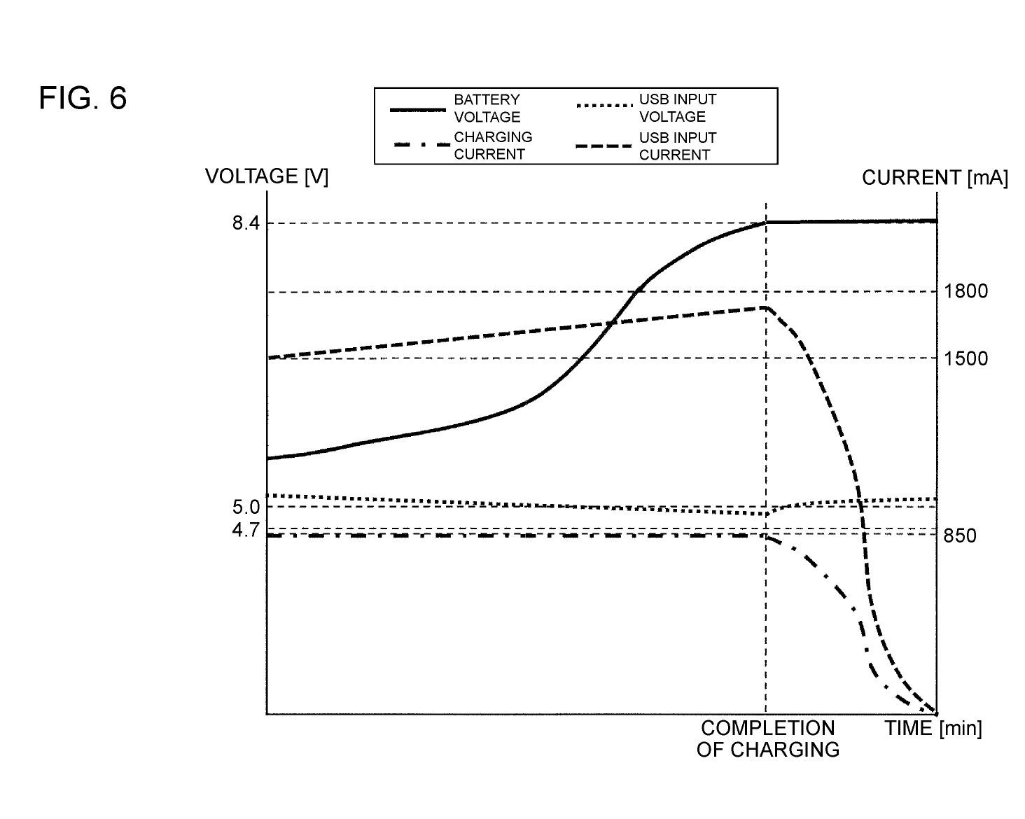

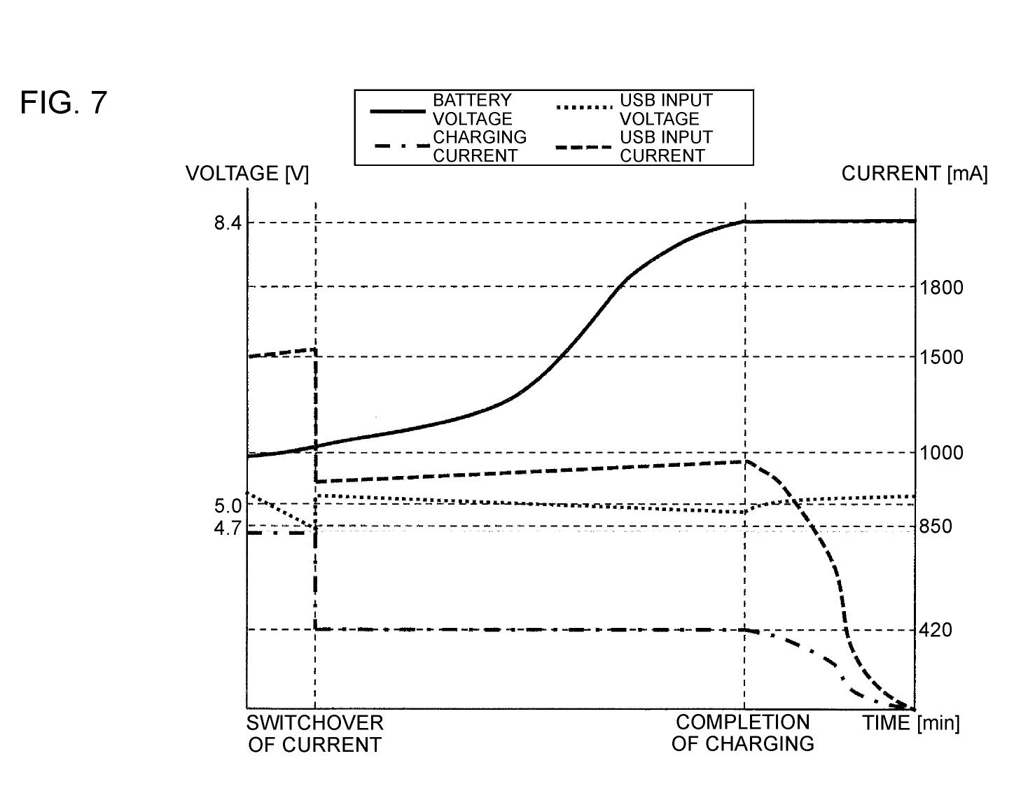

FIGS. 6 and 7 are graphs illustrating time variations in voltage and charging current of battery 200, output voltage (Vbus) of a USB power supply adaptor, and output current of the USB power supply adaptor in a charging operation performed by charging circuit 170 in digital camera 100 according to the exemplary embodiment.

FIG. 6 is the graph illustrating the time variations in battery voltage and others when digital camera 100 is coupled with USB power supply adaptor 300 that has enough power supply performance and thus can fully supply a charging current at the first set value (850 mA). In the example illustrated in FIG. 6, a set value for a charging current is set to the first set value (850 mA). The set value for the charging current is kept un-switched. This is due to that the USB power supply adaptor has enough power supply performance and thus can fully supply the charging current at the first set value (850 mA).

With reference to FIG. 6, once charging starts, the charging current is set to 850 mA. After that, as charging advances, a voltage of battery 200 rises. Since the charging current is constant, as the voltage of battery 200 rises, more power is required for charging of battery 200. Accordingly, more power is taken from USB power supply adaptor 300. Since power can be fully supplied under the power supply performance of USB power supply adaptor 300, the input voltage supplied from USB power supply adaptor 300 is approximately kept constant around 5 V. Accordingly, the current supplied from USB power supply adaptor 300 increases. Upon attainment of a fully charged state represented by a battery voltage reaching 8.4 V, the charging is completed.

FIG. 7 is the graph illustrating the time variations in battery voltage and others when digital camera 100 is coupled with USB power supply adaptor 300 that has less power supply performance and thus cannot fully supply a charging current at the first set value (850 mA). In the example in FIG. 7, a set value for the charging current is switched from the first set value (850 mA) to the second set value (420 mA).

In FIG. 7, upon beginning of charging, the charging current is initially set to the first set value (850 mA). Since the power supply performance of USB power supply adaptor 300 in FIG. 7 is not enough for charging with the charging current at the first set value (850 mA), upon beginning of charging, an input voltage supplied from USB power supply adaptor 300 lowers from 5.2 V to 4.7 V or below. Microcontroller 192 switches the set value for the charging current from the first set value to the second set value (420 mA). Since USB power supply adaptor 300 in FIG. 7 has the enough power supply performance for charging with the charging current at the second set value (420 mA), charging with the charging current takes place hereinafter. After that, upon attainment of a fully charged state represented by a battery voltage reaching 8.4 V, the charging is completed.

### [1-3. Effects and Others]

As described above, digital camera 100 according to the exemplary embodiment includes battery 200 (an example of a secondary battery) that is rechargeable, and charging circuit 170 (an example of a charging device) configured to charge battery 200. Charging circuit 170 includes voltage boosting circuit 180 (an example of a charger) configured to use power entered from USB power supply adaptor 300 (an example of an external device) to charge battery 200 with a charging current at a set current value, and charging control circuit 190 (an example of a charging controller) configured to control a current value for the charging current in voltage boosting circuit 180. Charging control circuit 190 sets, at beginning of charging of battery 200, the current value for the charging current in voltage boosting circuit 180 to a set value among a plurality of predetermined set values (first to third set values). Charging control circuit 190 switches, during charging of battery 200, when an input voltage supplied from USB power supply adaptor 300 is below a reference value (an example of a predetermined value), the current value for the charging current in voltage boosting circuit 180 to another set value among the plurality of set values.

As described above, charging control circuit 190 controls the current value for the charging current in battery 200 to an appropriate set value selected from among the plurality of set values in accordance with the power supply performance of USB power supply adaptor 300. Regardless of a type of USB power supply adaptor 300 (an example of an external device), efficient charging in accordance with the power supply performance of USB power supply adaptor 300 can be achieved.

Charging control circuit 190 may set, when an input voltage supplied from USB power supply adaptor 300 is below the reference value, the current value for the charging current in battery 200 to a set value that is lower than the set value being currently set.

Charging control circuit 190 may set, at beginning of charging of battery 200, the current value to a set value (e.g., first set value) that is highest among the plurality of set values. Charging control circuit 190 can efficiently set a set value for a charging current as higher as possible.

Charging control circuit 190 may control three types of set values as the plurality of set values. In the exemplary embodiment, by turning on and off of two transistors Tr1, Tr2, the three types of the set values are set.

Voltage boosting circuit 180 may be able to accept power from USB power supply adaptor 300 via communication in compliance with the universal serial bus (USB) standard. Voltage boosting circuit 180 can accept power via highly general-purpose communication.

A predetermined value to be compared with an input voltage supplied from USB power supply adaptor 300 may be set to a lower value than a lower limit value in the output voltage range specified in the USB standard. Charging control circuit 190 can determine the power supply performance of USB power supply adaptor 300 compliant with the USB standard.

Digital camera 100 (an example of an electronic device) may include battery 200 that is rechargeable, and charging circuit 170 configured to charge battery 200. Battery 200 according to the exemplary embodiment may be provided in various electronic devices. (Second exemplary embodiment)

In the first exemplary embodiment, the charge control for USB power supply adaptor illustrated in FIG. 5 has been described and exemplified. In the charge control for USB power supply adaptor, the first set value that is highest is first set as a set value for a charging current (S11), and, after that, when the power supply performance of USB power supply adaptor 300 is not enough, the set value is switched to a lower set value. A set value to be set first for a charging current is not limited to the first set value that is highest. A set value to be set first for a charging current may be a third set value that is lowest or a second set value that is an intermediate value. In other words, a current set value may be switched appropriately in accordance with the power supply performance of USB power supply adaptor 300 from the second set value or the third set value as a starting point. A charge control when the second or third set value is set as the starting point of the set value for the charging current will now be described.

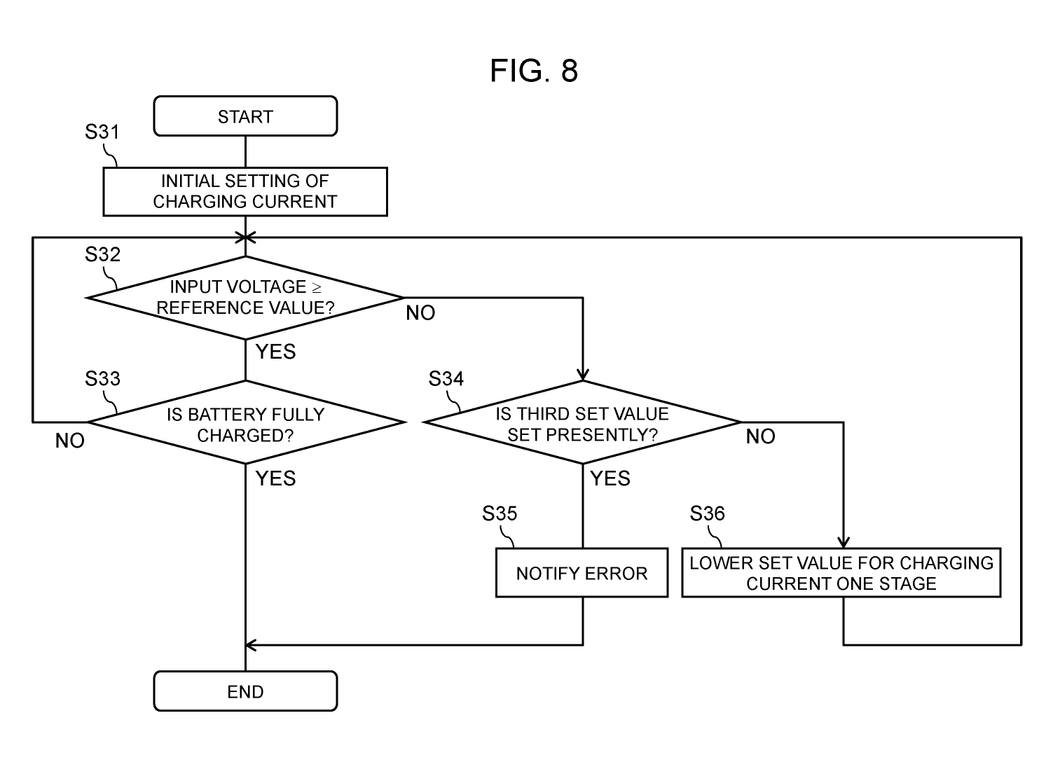

The flowcharts in FIG. 8 and FIG. 9 or 10 are flowcharts illustrating a charge control for USB power supply adaptor when the second or third set value is first set as a starting point of a set value for a charging current. The charge control for USB power supply adaptor according to the exemplary embodiment will now be described with reference to the flowcharts in FIG. 8 and FIG. 9 or 10.

In the flowchart in FIG. 8, microcontroller 192 first performs an initial setting for a charging current (S31). In the initial setting for the charging current, microcontroller 192 determines the power supply performance of USB power supply adaptor 300, and sets the charging current to one of the first to third set values based on a result of the determination. The initial setting process for the charging current (S31) will be described later in detail.

After the initial setting for the charging current is completed, microcontroller 192 charges battery 200 with the charging current at the set value that has been set. At that time, microcontroller 192 monitors a value of an input voltage (Vbus) to determine whether the input voltage is equal to or above a reference value (e.g., 4.7 V) (S32). When the input voltage is equal to or above the reference value (YES in S32), it can be determined that the set charging current can be fully supplied under the power supply performance of USB power supply adaptor 300. When the input voltage is equal to or above the reference value (YES in S32), battery 200 is kept charged until battery 200 is fully charged (S33). Upon attainment of a fully charged state in battery 200, the charging of battery 200 ends.

On the other hand, when the input voltage is below the reference value (NO in S32), it can be determined that the charging current cannot be fully supplied at the set value being currently set under the power supply performance of USB power supply adaptor 300. In this case, it is required that the current set value be lowered. However, when the present set value is the third set value that is lowest, the present set value cannot be lowered further.

When the input voltage is below the reference value (NO in S32), microcontroller 192 determines whether the set value for the present charging current is the third set value (S34). When the present set value is the third set value (YES in S34), the set value cannot be lowered further. Microcontroller 192 notifies an error to controller 135 (S35).

When the present set value is not the third set value (NO in S34), microcontroller 192 switches the set value for the charging current to a set value that is lower one stage (S36). For example, when the present set value for the charging current is the first set value, microcontroller 192 switches the set value to the second set value. Otherwise, when the present set value for the charging current is the second set value, microcontroller 192 switches the set value for the charging current to the third set value.

As described above, while determining the power supply performance of USB power supply adaptor 300 (S32), microcontroller 192 appropriately switches the charging current to a value in accordance with the power supply performance of USB power supply adaptor 300 (S36).

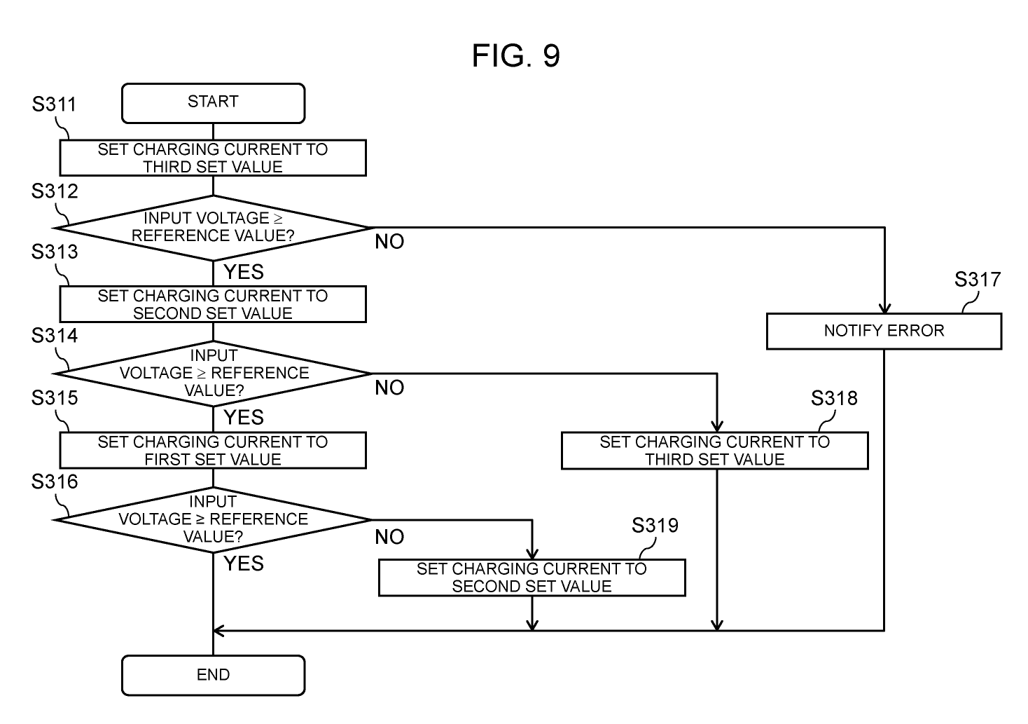

FIG. 9 is the flowchart illustrating specific processing of the initial setting process for the charging current (S31) in the flowchart in FIG. 8. The flowchart in FIG. 9 illustrates processing of the initial setting for the charging current when the third set value that is lowest is first set.

As illustrated in FIG. 9, microcontroller 192 first sets a set value for a charging current to the third set value that is lowest (S311). Next, microcontroller 192 determines the power supply performance of USB power supply adaptor 300 (S312). Specifically, microcontroller 192 monitors a value of the input voltage (Vbus) supplied from USB power supply adaptor 300 to determine whether the input voltage is equal to or above the reference value (S312). When the charging current cannot be fully supplied at the third set value being currently set under the power supply performance of USB power supply adaptor 300, the input voltage lowers significantly. Microcontroller 192 can monitor the input voltage to determine the power supply performance of USB power supply adaptor 300.

Even when a charging current cannot be fully supplied at the third set value being currently set under the power supply performance of USB power supply adaptor 300, microcontroller 192 cannot lower the set value further. When the input voltage is below the reference value (NO in S312), microcontroller 192 notifies an error to controller 135 (S317).

On the other hand, when the input voltage is equal to or above the reference value (YES in S312), it can be determined that the charging current can be fully supplied at the third set value being currently set under the power supply performance of USB power supply adaptor 300. In this case, microcontroller 192 determines whether the charging current can be supplied at the set value that is one stage higher under the power supply performance of USB power supply adaptor 300. Microcontroller 192 switches the set value for the charging current to the second set value that is one stage higher (S313), compares the input voltage (Vbus) with the reference value, and determines the power supply performance of USB power supply adaptor 300 (S314).

As a result of the determination, when the input voltage is below the reference value (NO in S314), it can be determined that the charging current cannot be fully supplied at the second set value being currently set under the power supply performance of USB power supply adaptor 300. Microcontroller 192 sets the set value for the charging current to the third set value that is one stage lower (S318).

On the other hand, when the input voltage is equal to or above the reference value (YES in S314), it can be determined that the charging current can be fully supplied at the second set value being currently set under the power supply performance of USB power supply adaptor 300. At this time, microcontroller 192 switches the set value for the charging current to the first set value that is one stage higher (S315), compares the input voltage (Vbus) with the reference value, and determines the power supply performance of USB power supply adaptor 300 (S316).

When the input voltage is below the reference value (NO in S316), it can be determined that the charging current cannot be fully supplied at the first set value being currently set under the power supply performance of USB power supply adaptor 300. Microcontroller 192 switches the set value for the charging current to the second set value that is one stage lower (S319).

On the other hand, when the input voltage is equal to or above the reference value (YES in S316), it can be determined that the charging current can be fully supplied at the first set value being currently set under the power supply performance of USB power supply adaptor 300. In this case, microcontroller 192 keeps the first set value for the set value for the charging current.

With the processing as described above, even when the third set value is served as the starting point of the set value for the charging current, microcontroller 192 can initially set a charging current appropriately in accordance with the power supply performance of USB power supply adaptor 300.

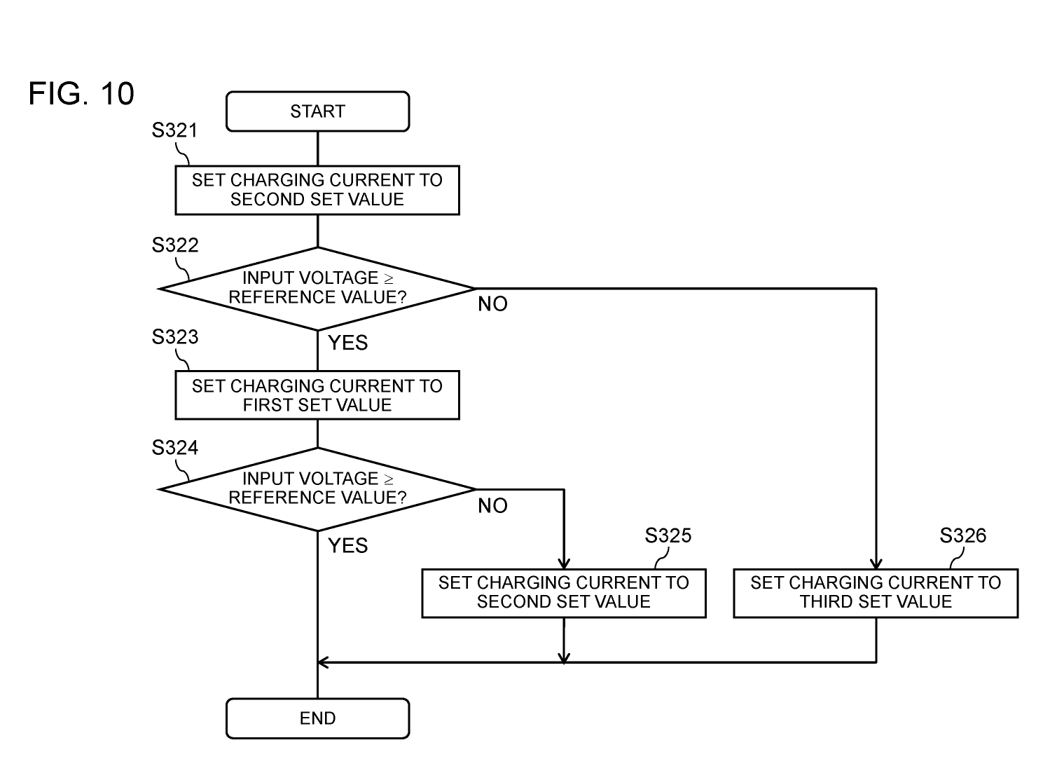

FIG. 10 is the flowchart illustrating another example of the initial setting process for a charging current (S31) in the flowchart in FIG. 8. The flowchart in FIG. 10 illustrates processing of the initial setting for the charging current when the second set value is set as the starting point.

In FIG. 10, microcontroller 192 first sets a set value for the charging current to the second set value that is an intermediate value (S321). Next, microcontroller 192 compares an input voltage (Vbus) with the reference value to determine the power supply performance of USB power supply adaptor 300 (S322). Specifically, microcontroller 192 monitors a value of the input voltage (Vbus) to determine whether the input voltage is equal to or above the reference value (e.g., 4.7 V) (S322).

When the charging current cannot be fully supplied at the second set value being currently set under the power supply performance of USB power supply adaptor 300, the input voltage lowers significantly. When the input voltage is below the reference value (NO in S322), microcontroller 192 switches the set value for the charging current to the third set value that is one stage lower (S326).

On the other hand, when the input voltage is equal to or above the reference value (YES in S322), it can be determined that the charging current can be fully supplied at the second set value being currently set under the power supply performance of USB power supply adaptor 300. In this case, microcontroller 192 determines whether the charging current can be supplied at the set value that is one stage higher under the power supply performance of USB power supply adaptor 300. Microcontroller 192 switches the set value for the charging current to the first set value that is one stage higher (S323) to determine the power supply performance of USB power supply adaptor 300 (S324).

When the charging current cannot be fully supplied at the first set value being currently set under the power supply performance of USB power supply adaptor 300, the input voltage lowers significantly. When the input voltage is below the reference value (NO in S324), microcontroller 192 switches the set value for the charging current to the second set value that is one stage lower (S325).

On the other hand, when the input voltage is equal to or above the reference value (YES in S324), it can be determined that the charging current can be fully supplied at the first set value being currently set under the power supply performance of USB power supply adaptor 300. In this case, microcontroller 192 keeps the first set value for the set value for the charging current.

With the processing performed by microcontroller 192, as described above, even when the second set value is served as the starting point of the set value for the charging current, a charging current is set appropriately in accordance with the power supply performance of USB power supply adaptor 300.

### Other Exemplary Embodiments

The first and second exemplary embodiments have been described above as examples of the technique disclosed in the present application. However, the technique according to the present disclosure is not limited to the first and second exemplary embodiments, but is applicable to other exemplary embodiments including appropriate modifications, replacements, additions, omissions, and the like. In addition, new exemplary embodiments can be made by combining components described in the first and second exemplary embodiments. Hence, other exemplary embodiments will be described below.

In the above described exemplary embodiments, the set value for the charging current can be selected from among the three types of the set values, i.e., the first to third set values. However, a number of set values to be selected for a charging current is not limited to three. A set value may be selected from among four or more types of set values. Further, in this case, when a value of a level where an input voltage is lower than the reference value is lower than a predetermined value, a set value for a charging current may be lowered one stage, as illustrated in the first and second exemplary embodiments. On the other hand, when a value of a level where the input voltage is lower than the reference value is higher than the predetermined value, the set value for the charging current may be lowered two or more stages. Similarly, when a value of a level where the input voltage is higher than the reference value is higher than a predetermined value, the set value for the charging current may be increased one stage, as illustrated in the second exemplary embodiment. On the other hand, a value of a level where the input voltage is higher than the reference value is higher than the predetermined value, the set value for the charging current may be increased two or more stages.

The above exemplary embodiments have been described with reference to the digital camera as an example of an electronic device. However, the charge control in charging circuit 170, according to the present disclosure, can be applied to other electronic devices. For example, the charge control according to the present disclosure is applied as well to electronic devices configured to accept power supplied from an external device to charge a built-in battery (e.g., smartphones, portable telephones, and electronic devices capable of performing USB communication).

In the above described exemplary embodiments, the processing illustrated in the flowcharts in FIG. 5, and FIGS. 8 to 10 has been applied when a USB power supply adaptor is coupled. However, the processing illustrated in the flowcharts in FIGS. 8 to 10 may be applied when another external device (electronic device configured to supply power) than a USB power supply adaptor is coupled.

In the above described exemplary embodiments, charging circuit 170 determines the power supply performance of the USB power supply adaptor (an example of an external device) based on the input voltage (Vbus) supplied from the USB power supply adaptor (an example of an external device configured to accept power). Charging circuit 170 may determine the power supply performance of the USB power supply adaptor (an example of an external device) based on other information than the input voltage (Vbus).

The above exemplary embodiments have been described that charging circuit 170 uses power supplied from an external device via communication in compliance with the USB standard to perform charging. However, even when power is accepted from an external device via communication in compliance with another standard than the USB standard, the idea of the present disclosure can be obviously applied.

In the above described exemplary embodiments, charging circuit 170 causes voltage boosting circuit 180 to boost up a voltage accepted from the Vbus terminal to the predetermined voltage (8.4 V), and the voltage boosted up is used to charge battery 200. A voltage (e.g., 12V) that is higher than the predetermined voltage (8.4 V) may be supplied from the Vbus terminal compliant with the USB standard (e.g., USB power delivery). In this case, charging circuit 170 is required to lower the voltage accepted via the Vbus terminal to the predetermined voltage (8.4 V). By taking into account various situations, charging circuit 170 may include a voltage step-down circuit, instead of voltage boosting circuit 180, or in addition to voltage boosting circuit 180.

The exemplary embodiments have been described herein as examples of the technique in the present disclosure. For this purpose, the accompanying drawings and the detailed description have been provided.

Accordingly, the components described in the accompanying drawings and the detailed description may include not only the components essential for solving the problem but also components that are not essential for solving the problem in order to illustrate the technique. For this reason, even if these unessential components are described in the accompanying drawings and the detailed description, these unessential components should not be immediately approved as being essential.

The above exemplary embodiments are provided to exemplify the technique according to the present disclosure, and various changes, replacements, additions, omissions, and the like can be made within the scope of the claims and equivalents thereof.

The present disclosure is advantageous for a charging circuit configured to use power supplied from an external device to charge a built-in secondary battery.

What is claimed is:

1. A charging device comprising:
a charger configured to charge a secondary battery with a charging current at a current value being presently set, the charging is carried out by using power entered from an external device; and
a charging controller configured to set the current value,
wherein the charging controller
sets, at beginning of charging of the secondary battery, the current value to a set value among a plurality of set values predetermined, and
sets, during charging of the secondary battery, when an input voltage from the external device lowers below a predetermined value, the current value to another set value among the plurality of set values.

2. The charging device according to claim 1, wherein the charging controller sets, when the input voltage from the external device lowers below the predetermined value, the current value to an other set value among the plurality of set values, the other set value being lower than the set value being presently set.

3. The charging device according to claim 1, wherein the charging controller sets, at the beginning of charging of the secondary battery, the current value to a highest set value among the plurality of set values.

4. The charging device according to claim 1, wherein the charging controller controls three types of set values as the plurality of set values.

5. The charging device according to claim 1, wherein the charger allows the power to enter from the external device via communication in compliance with a universal serial bus (USB) standard.

6. The charging device according to claim 5, wherein the predetermined value is set to a value lower than a lower limit value in an output voltage range specified in the USB standard.

7. An electronic device comprising:
a rechargeable secondary battery; and
the charging device according to claim 1, the charging device being configured to charge the rechargeable secondary battery.
